(19) United States
(12) Patent Application Publication
(10) Pub. No.: US 2005/0109187 A1
(43) Pub. Date: May 26, 2005

(54) Method and apparatus for scribing tile

(76) Inventor: Clyde Lewell Smith, St. Louis, MO (US)

Correspondence Address: Clyde Lewell Smith, 7038 Nashville Ave., St. Louis, MO, 63117, US

(21) Appl. No.: 10/721,041

(22) Filed: Nov. 24, 2003

(51) Int. Cl. B26D 3/08

(52) U.S. Cl. 83/880; 83/743

(57) ABSTRACT

A method and apparatus for scribing tile is disclosed. The disclosed scribing tool preferably comprises a scribe member, a tile engagement member, and an extension member. The extension member is preferably pivotally connected to the scribe member and both pivotally and slideably connected to the tile engagement member in a manner connecting the tile engagement member to the scribe member. The scribing tool also preferably comprises a locking member that is biased toward a position that prevents relative movement between the extension member and the tile engagement member.

### BACKGROUND OF THE INVENTION

In the art of laying tile, it is often necessary to trim or cut tiles to fit against various boundary perimeters. The act of scribing such tile is often the most laborious and time consuming step of a tiling project. Furthermore, inaccuracies or mistakes made while scribing tile often results in wasted tile and increases the time it takes to complete tiling projects. As such, many techniques and devices have been developed in an effort reduce the time and complexity of the tile scribing process.

Some techniques of scribing tile involve the use of tools that are specifically adapted for such purpose. Examples of such tools include those described in the disclosures of U.S. Pat. Nos. 5,701,680, 5,617,642, 5,483,749, 5,471,758, 5,361,508, 4,827,625, 3,718,980, and 2,770,043, which disclosures are hereby incorporated into this disclosure by reference. While at least some of such devices allow a person to scribe tile accurately to a boundary perimeter, in general, they are also cumbersome and time consuming to utilize. In particular, such devices often include many adjustable components that must be set and locked relative to each other, often by using threaded fasteners, thereby making such devices difficult to utilize with only two hands. On the other hand, other devices, while being relatively simple and quick to utilize, lack versatility and are often only suited for specific scribing tasks.

As a result of the above-mentioned disadvantages associated with previously developed scribing tools, the act of scribing tile is most often performed using conventional tools, such as rulers, or by using other techniques well known in that art of tiling, such as inverting tiles. These techniques typically involve measuring and marking multiple reference points on a tile and then scribing the tile between such points. While such techniques can be used to scribe tile to either simple or complex boundary perimeters, these techniques also create numerous opportunities for mistakes to be made and, in some cases, can be very tedious and time consuming to utilize. Nonetheless, these manual measuring techniques are typically favored over the use of specifically adapted scribing tools, such as those discussed above, due to the described disadvantages associated with such scribing tools.

### SUMMARY OF THE INVENTION

The scribing tool of the present invention was specifically developed to provide and alternative to prior art scribing tools and manual measuring techniques, and to overcome the disadvantages associated therewith. As a result, the scribing tool of the present invention allows tile to be scribed accurately and rapidly using just a few simple steps. Additionally, the scribing tool of the present invention is versatile and is low in cost to produce.

In a first aspect of the invention, an apparatus for scribing tile comprises a scribe member, a tile engagement member, an extension member, and a locking member. The extension member connects the scribe member to the tile engagement member and is movably connected to the tile engagement member. The locking member is movable between a locking position and an unlocking position and prevents movement of the tile engagement member relative to the extension member when in its locking position, while allowing movement of the tile engagement member relative to the extension member when in its unlocking position. Additionally, the locking member is biased from the unlocking position toward the locking position.

In a second aspect of the invention, a method comprises providing a surface onto which it is desired to lay tile up to a boundary perimeter. The method further comprises the step of providing first, second, and third tiles. The first and second tiles each have a straight edge and the third tile has first and second straight edges. The method yet further comprises, securing the first and second tiles to the surface in a manner such that the edge of the first tile is oriented generally perpendicular to the edge of the second tile and in a manner defining a portion of the surface that is at least partially bound by the edge of the first tile, the edge of the second tile, and the boundary perimeter.

Still further, the method includes the step of providing a scribing tool that comprises a scribe member, a tile engagement member, and an extension member. The extension member connects the scribe member to the tile engagement member and is pivotally connected to the tile engagement member. The tile engagement member comprises first, second, third, and fourth engagement portions.

This method also includes the steps of aligning the scribe member with a portion of the boundary perimeter and engaging the tile engagement member with the first and second tiles. The engagement of the tile engagement member with the first and second tiles occurs by pivoting the tile engagement member relative to the extension member in a manner such that the first engagement portion of the tile engagement member engages the edge of the first tile and such that the second engagement portion of the tile engagement member engages the edge of the second tile, while the scribe member is aligned with the portion of the boundary perimeter.

Still further, the method comprises locking the tile engagement member relative to the extension member in a manner such that the scribe member is fixed in orientation relative to the tile engagement member with the tile engagement member engaged with the first and second tiles as recited and with the scribe member aligned with the portion of the boundary perimeter as recited. Additionally, the method comprises engaging the tile engagement member with the third tile in a manner such that the third engagement portion of the tile engagement member engages the first edge of the third tile and such that the fourth engagement portion of the tile engagement member engages the second edge of the third tile. This occurs while the tile engagement member is locked in the fixed orientation relative to the extension member and in a manner such that the first edge of the third tile is separated from the first engagement portion of the tile engagement member by a distance and the second edge of the third tile is separated from the second engagement portion of the tile engagement member by the same distance.

Finally, this method comprises scribing the third tile via the scribe member when the tile engagement member is engaged with the third tile as recited.

In a third aspect of the invention, a method comprises providing a scribing tool. The scribing tool comprises a scribe member, a tile engagement member, an extension member, and a locking member. The extension member connects the scribe member to the tile engagement member and is movably connected to the tile engagement member. The locking member is movable between a locking position and an unlocking position, wherein it prevents movement of the tile engagement member relative to the extension member when in the locking position and allows movement of the tile engagement member relative to the extension member when in the unlocking position. The locking member is also biased from the unlocking position toward the locking position.

The method further includes moving the extension member relative to the tile engagement member by applying a force causing the locking member to move out of the locking position and into the unlocking position. Still further, the method comprises releasing the applied force on the locking member in a manner such that the locking member moves out of the unlocking position and into the locking position as a result of the locking member being biased from the unlocking position toward the locking position.

While the principal advantages and features of the invention have been described above, a more complete and thorough understanding of the invention may be obtained by referring to the drawings and the detailed description of the preferred embodiments, which follow.

### BRIEF DESCRIPTION OF THE DRAWINGS

FIG. 1 is a perspective view of the preferred embodiment of a scribing tool in accordance with the invention.

FIG. 2 is a broken top view of the scribe member of the scribing tool shown in FIG. 1.

FIG. 3 is a side view of the scribe member shown in FIG. 2.

FIG. 4 is a broken top view of the extension member of the scribing tool shown in FIG. 1.

FIG. 5 is a broken bottom view of the extension member shown in FIG. 4.

FIG. 6 is a side view of the extension member shown in FIG. 4.

FIG. 7 is a broken cross-sectional view of the extension member shown in FIG. 4, taken about the line 7-7 shown in FIG. 4.

FIG. 8 is a top view of the upper portion of the tile engagement member of the scribing tool shown in FIG. 1.

FIG. 9 is a perspective view of the upper portion of the tile engagement member shown in FIG. 8, as seen from beneath the upper portion.

FIG. 10 is a cross-sectional view of the upper portion of the tile engagement member shown in FIG. 8, taken about the line 10-10 shown in FIG. 8.

FIG. 11 is a top view of the lower portion of the tile engagement member of the scribing tool shown in FIG. 1.

FIG. 12 is a perspective view of the lower portion of the tile engagement member shown in FIG. 11, as seen from beneath the lower portion.

FIG. 13 is a cross-sectional view of the lower portion of the tile engagement member shown in FIG. 11, taken about the line 13-13 shown in FIG. 11.

FIG. 14 is a perspective view of the locking member of the scribing tool shown in FIG. 1, as seen from above the locking member.

FIG. 15 is a perspective view of the locking member shown in FIG. 14, as seen from beneath the locking member.

FIG. 16 is a top view of the locking member shown in FIG. 14.

FIG. 17 is a bottom view of the locking member shown in FIG. 14.

FIG. 18 is a front view of the locking member shown in FIG. 14.

FIG. 19 is a side view of the locking member shown in FIG. 14.

FIG. 20 is a cross-sectional view of the locking member, taken about the line 20-20 shown in FIG. 16.

FIG. 21 is a cross-sectional view of the locking member, taken about the line 21-21 shown in FIG. 17.

FIG. 22 is a top view of the tile engagement member, the locking member, and a portion of the extension member of the scribing tool shown in FIG. 1, with such components assembled together.

FIG. 23 is a cross-sectional view of the assembly shown in FIG. 22, taken about the line 23-23 shown in FIG. 22, and is shown with the locking member in its locking configuration.

FIG. 24 is a cross-sectional view similar to the view of FIG. 23, but with the locking member in its unlocking configuration.

FIG. 25 is a perspective view of the scribing tool shown in FIG. 1 being utilized to measure to a portion of a boundary perimeter of a space onto which a tile is sought to be laid.

FIG. 26 is a perspective view of the scribing tool shown in FIG. 1 being utilized to indicate where to scribe a tile so that the tile will fit in the space shown in FIG. 25.

Reference characters in the written specification indicate corresponding items shown throughout the drawing figures.

### DETAILED DESCRIPTION OF THE PREFERRED EMBODIMENTS OF THE INVENTION

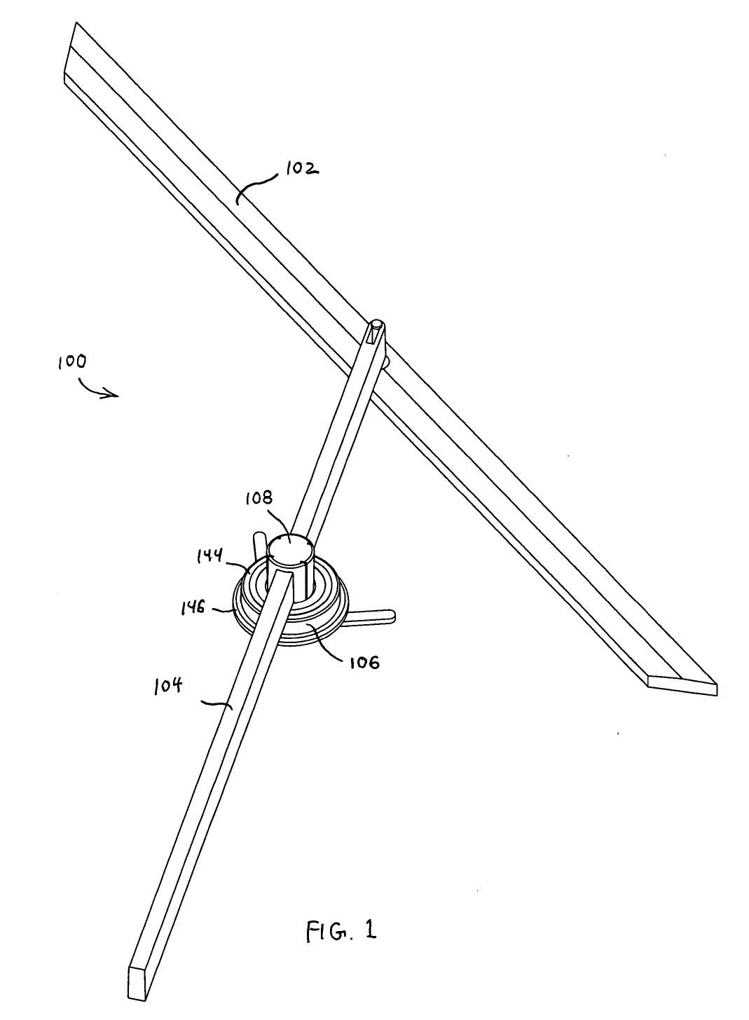

A preferred embodiment of a scribing tool in accordance with the invention is shown in its entirety in FIGS. 1, 25, and 26. In general, the scribing tool 100 preferably comprises a scribe member 102, an extension member 104, a tile engagement member 106, and a locking member 108.

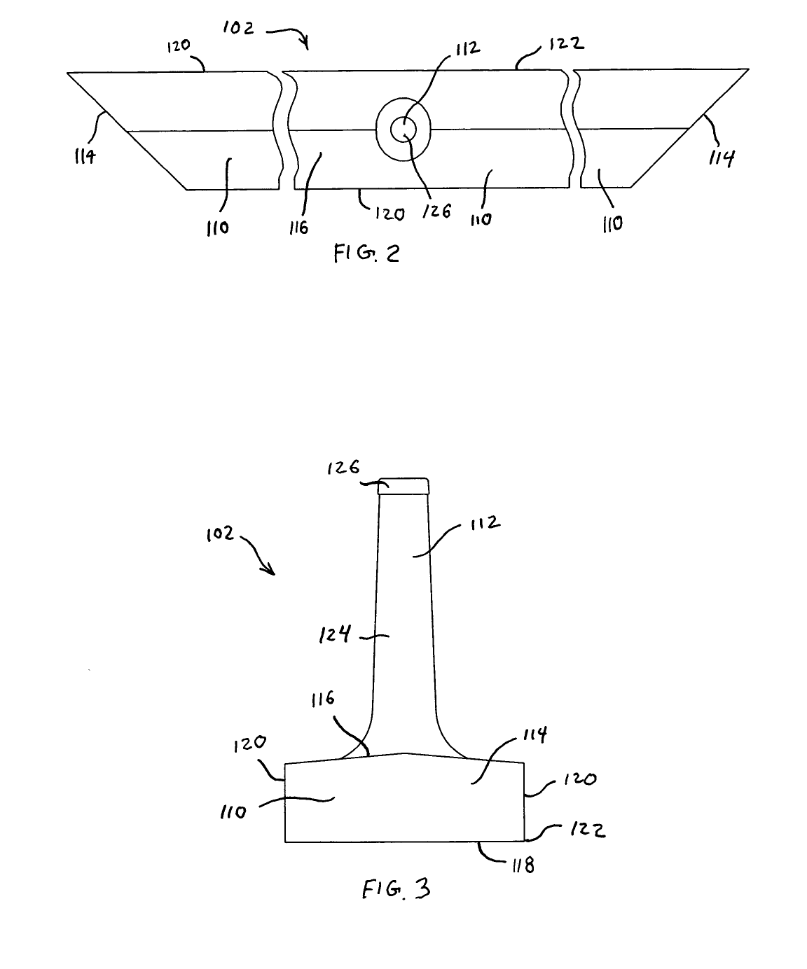

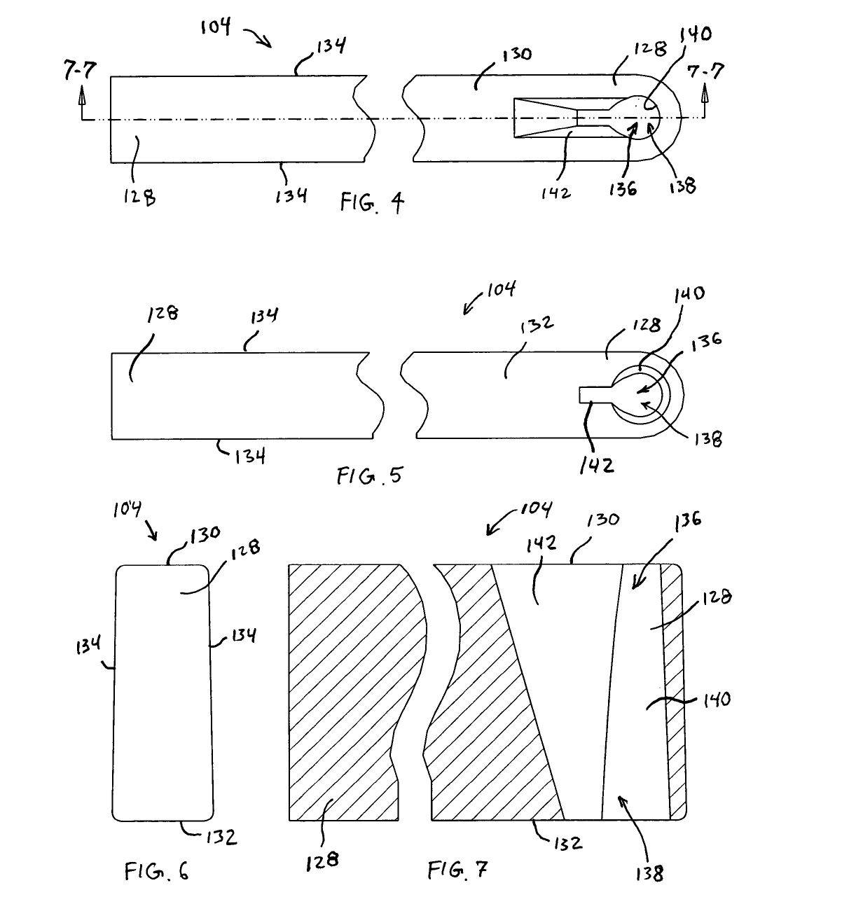

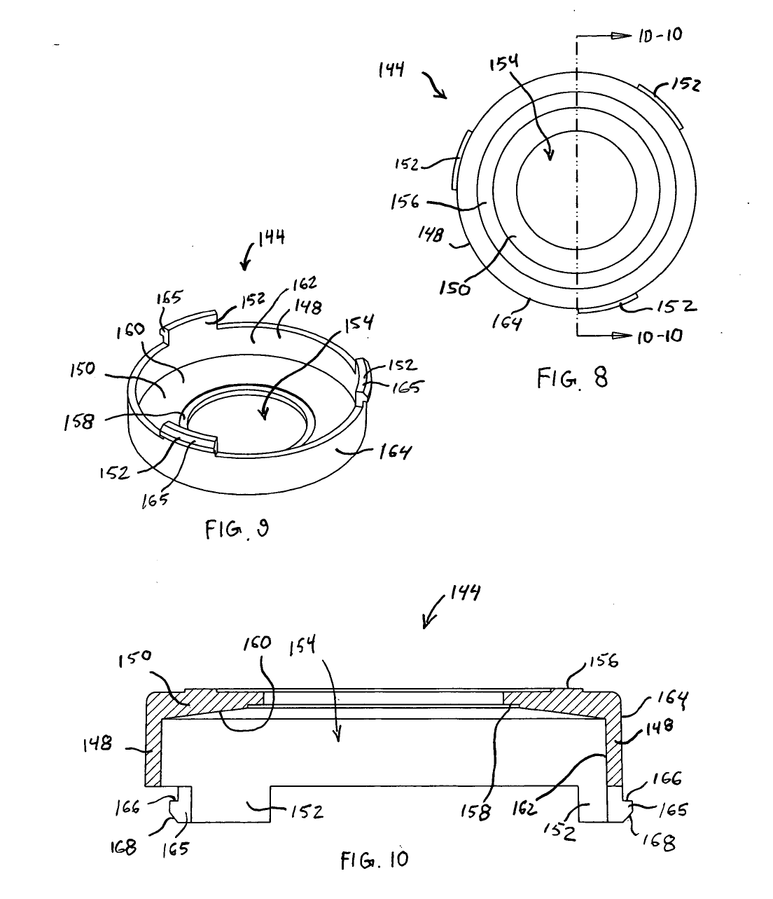

The scribe member 102 of the scribing tool 100, shown by itself in FIGS. 2 and 3, preferably comprises a beam portion 110 and an attachment portion 112. Configured as shown, the scribe member 102 is preferably fabricated as a single monolithic molded component of plastic or metal. The beam portion 110 has a longitudinal length that extends between opposite longitudinal ends 114. The beam portion 110 also preferably comprises a top 116, a bottom 118, and opposite sides 120 that extend between its longitudinal ends 114. The bottom 118 of the beam portion 110 is preferably flat and preferably forms a straight edge 122 with at least one of the opposite sides 120. The top 116 of the beam portion 110 is preferably peaked in manner such that its surfaces are non-parallel to the bottom 118 of the beam portion. This facilitates the easy removal of the scribe member 102 from two-part a mold during its formation. The opposite longitudinal ends 114 of the beam portion 110 each preferably forms an acute angle of preferably forty-five degrees with the straight edge 122.

The attachment portion 112 of the scribe member 102 is preferably centrally located between the longitudinal ends 114 of the beam portion 110 and protrudes upward from the top 116 of the beam portion. The attachment portion 112 preferably comprises a frustoconical column 124 that gradually reduces in diameter as it extends upward from the top 116 of the beam portion 110. The top of the attachment portion terminates with a nub 126 that is slightly larger in diameter than the portion of the column 124 immediately beneath the nub.

The extension member 104 of the scribe tool 100 is shown by itself in FIGS. 4-7. The extension member 104 is preferably an elongated member having a cross-section, as shown in FIG. 6, that generally extends between its opposite longitudinal ends 128 and, like the scribe member 102, is preferably fabricated as a single monolithic molded component of plastic or metal. Additionally, the extension member 104 preferably has a flat top 130, a flat bottom 132, and opposite sides 134. The sides 134 of the extension member 104 preferably taper toward each other as they extend upward between the bottom 132 and top 130 of the extension member to facilitate easy removal of the extension member 104 from a two-part mold during its formation. One of the longitudinal ends 128 of the extension member 104 is preferably provided with an attachment portion 136.

The attachment portion 136 of the extension member 104 preferably comprises an opening 138 that extends vertically from the top 130 to the bottom 132 of the extension member. The opening 138 preferably has a partial frustoconical surface 140 that joins with an adjacent slot portion 142. The partial frustoconical surface 140 tapers toward itself as it extends upward from the bottom 132 to the top 130 of the extension member 104. The slot portion 142 has a length that extends along the longitudinal direction of the extension member 104 and a width that extends perpendicular to the sides 134 of the extension member. The length of the slot portion 142 is preferably greater than the slot portion's width. Additionally, the slot portion 142 preferably slopes lengthwise away from the partial frustoconical surface 140, while also expanding widthwise, as the slot portion extends upward from the bottom 132 to the top 130 of the extension member 104. This configuration of the attachment portion 136, like the overall configuration of the extension member 104 facilitates the easy removal of the extension member from a two-part mold during its formation.

The tile engagement member 106 preferably comprises separate upper portion 144 and lower 146 portions, both of which are preferably formed of plastic material via two-part molds. The upper portion 144 is shown by itself in FIGS. 8-10 and preferably comprises a generally frustoconical wall portion 148, a top wall portion 150, and a plurality of locking tabs 152. The frustoconical wall portion 148 preferably tapers toward its center axis slightly as it extends upward from the locking tabs 152 to the top wall portion 150, so as to accommodate the draft angles necessary for molded production. The top wall portion 150 preferably extends radially inward from the top of the frustoconical wall portion 148 and has a generally cylindrical central opening 154. A raised annular rim 156 preferably protrudes upward from the top wall portion 150. The bottom side of the top wall portion 150 preferably comprises a recessed annular rim 158 and a frustoconical sloped cam surface 160. The recessed annular rim 158 is positioned immediately adjacent the central opening 154 of the top wall portion 150 and is preferably planer. The sloped cam surface 160 of the top wall portion 150 preferably tapers radially inward as it extends upward from the frustoconical wall portion 148 to the recessed annular rim 158.

The upper portion 144 of the tile engagement member 106 preferably has three locking tabs 152 that extend downward from the frustoconical wall portion 148, matching the contour of the inner surface 162 of the frustoconical wall portion as they so extend. The locking tabs 152 are preferably equally spaced, and a portion of each locking tab also matches the contour of the outer surface 164 of the frustoconical wall portion 148 as the locking tabs extend downward therefrom. However, each locking tab 152 also has a barb 165 that extends radially outward from the outer surface 164 of the frustoconical wall portion 148, thereby creating opposite locking 166 and cam 168 surfaces. The locking surfaces 166 of the locking tabs 152 are preferably coplanar while the cam surfaces 168 slope radially outward as they extend upward.

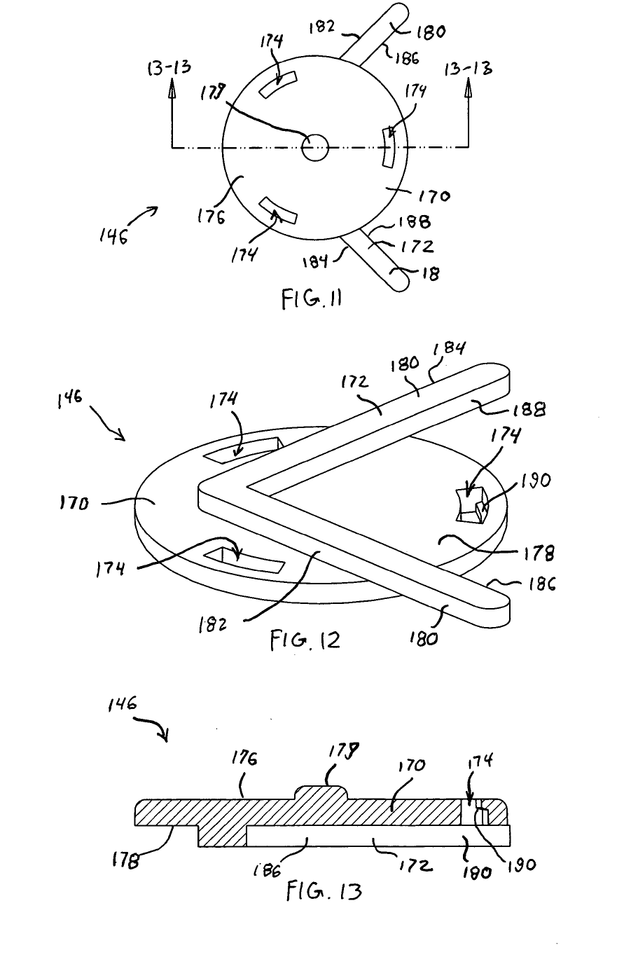

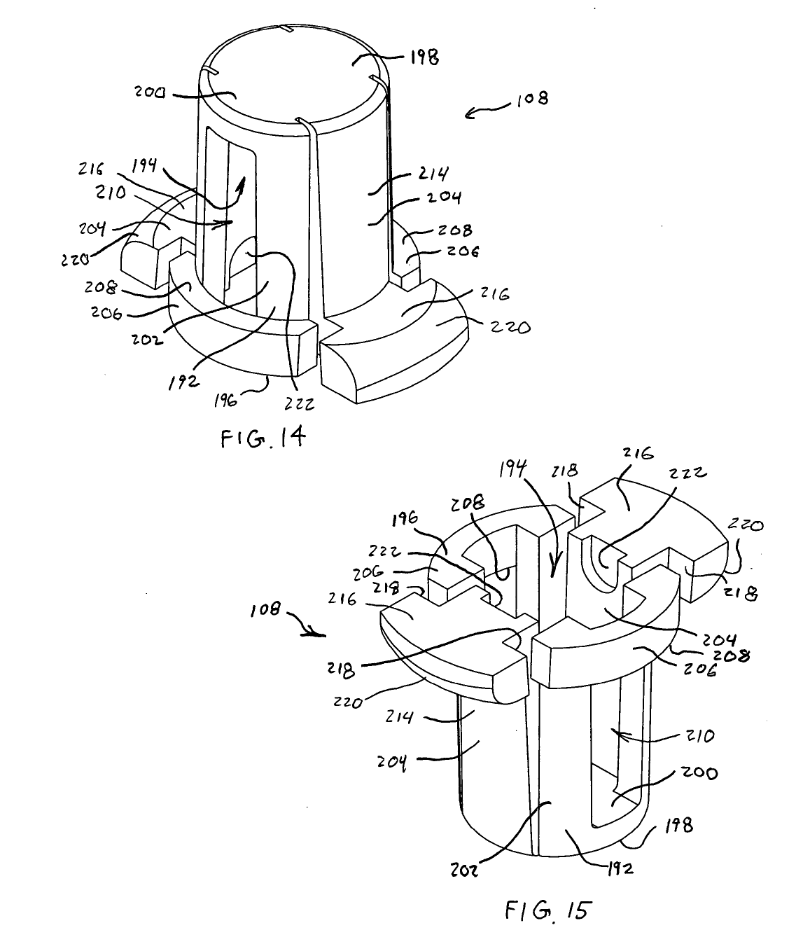

The lower portion 146 of the tile engagement member 106 is shown by itself in FIGS. 11-13 and preferably comprises a generally discoidal main body 170 and an L-shaped protrusion 172 that extends downward therefrom. Like many of the other components of the scribing tool 100, the lower portion 146 of the tile engagement member 106 is preferably formed of plastic or metal material and is preferably configured to be molded via a two-part mold. A plurality of openings 174 extend through the main body 170 from the main body's opposite top 176 and bottom 178 surfaces. The top surface 176 of the main body 170 is preferably generally flat with the exception of a centrally positioned cylindrical nub portion 179 that extends upward. The L-shaped protrusion 172 preferably forms two legs 180 that are oriented at a right-angle relative to each other. Each of the legs 180 preferably extends beyond the outer diameter of the main body 170. The legs 180 of the L-shaped protrusion 172 preferably form first 182, second 184, third 186, and fourth 188 engagement portions that extend vertically downward from the bottom surface 178 of the main body 170. The openings 174 of the main body 170 of the lower portion 146 are preferably equally spaced and each preferably extends along an arc that shares a common axis with the circumference of the main body. Portions of the main body 170 preferably extend radially inward into each opening 174 adjacent the top surface 176 of the main body, thereby forming locking surfaces 190.

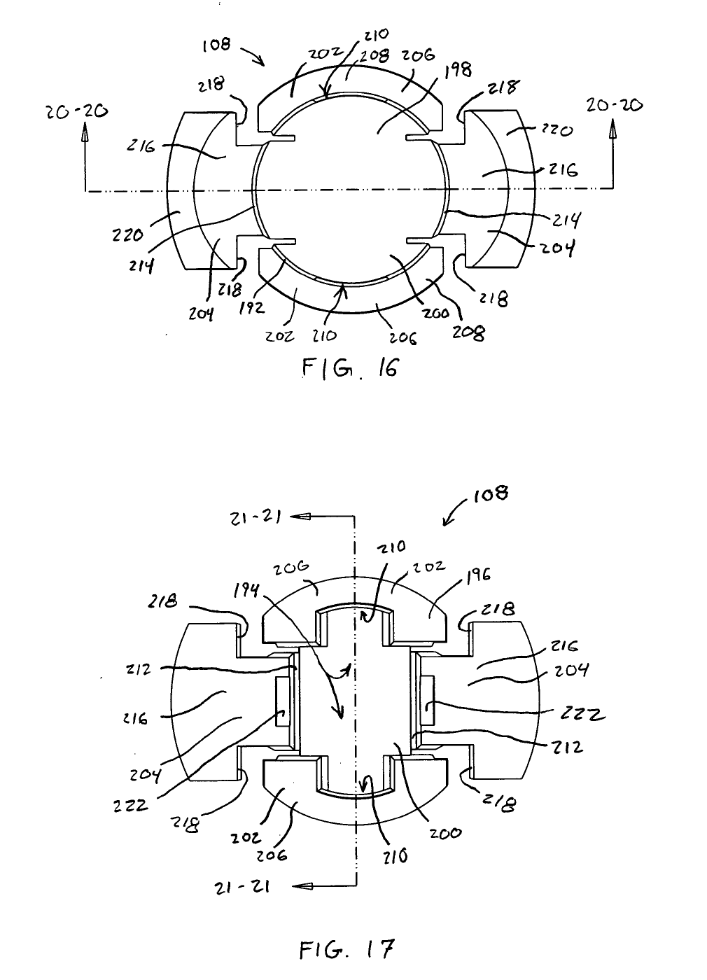

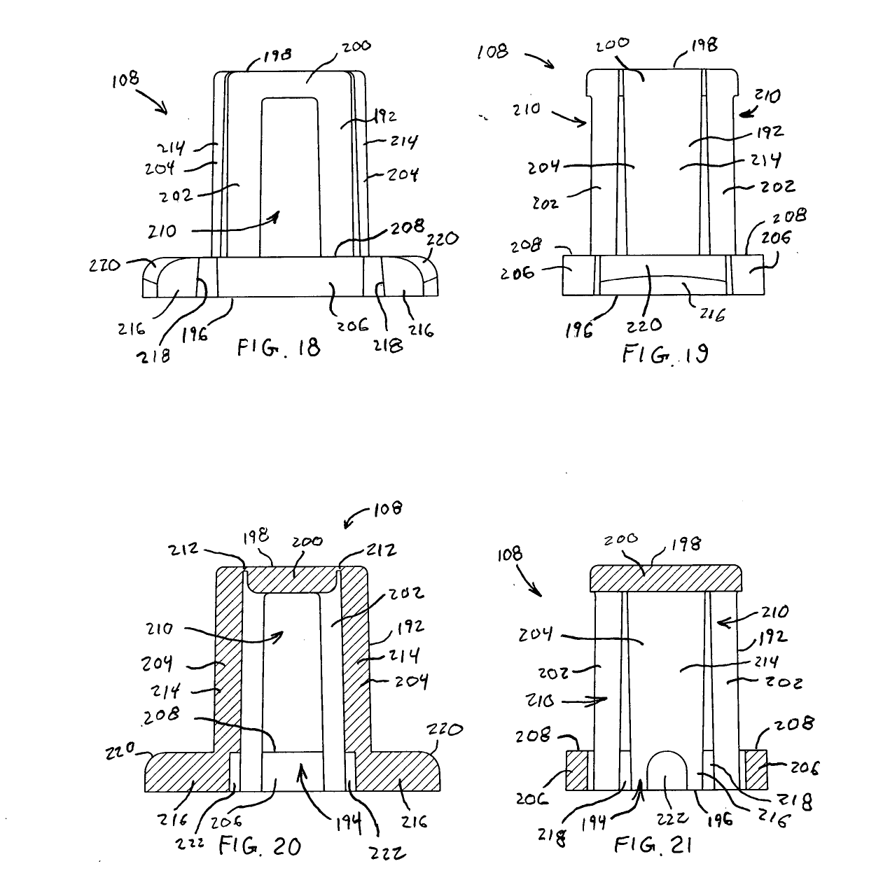

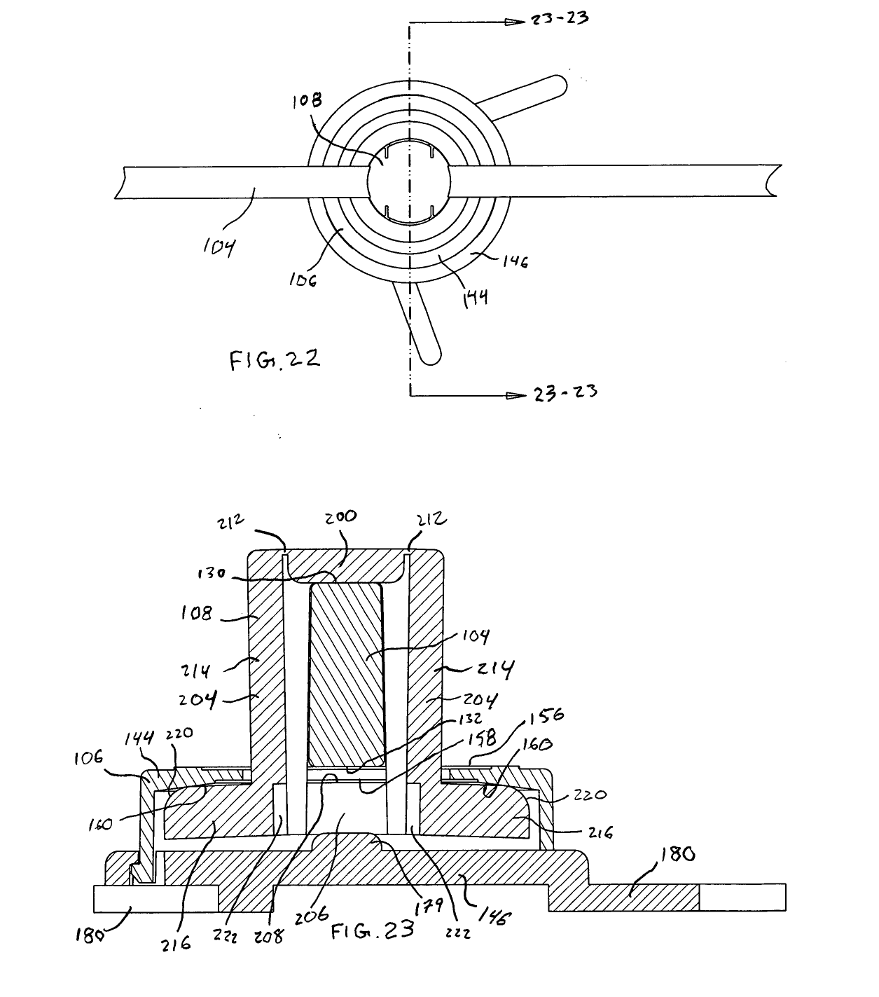

Like the above-mentioned components of the scribing tool 100, the locking member 108, shown by itself in FIGS. 14-21, is preferably formed of plastic or metal and is preferably configured to be molded as a single monolithic piece via a two-part mold. The locking member 108 preferably comprises a main, generally frustoconical, outer surface 192 that extends circumferentially about a vertical axis and that tapers toward itself as it extends upward. The main outer surface 192 is preferably frustoconical in shape to accommodate a draft-angle for purposes of facilitating the molding of the locking member 108. A primary opening 194 preferably extends upward through the center of the locking member 108 from the bottom surface 196 of the locking member and terminates short of the top surface 198 of the locking member. Extending downward from its upper portion 200, the locking member 108 preferably comprises opposite side wall portions 202 and a pair of opposite leg portions 204, with the leg portions being positioned circumferentially between the side wall portions. The side wall portions 202 are preferably identical and each preferably eventually terminates in a manner forming an arcuate rim portion 206 that extends radially outward from the main outer surface 192 of the locking member 108. The rim portions 206 are configured such that they form coplanar upward facing bearing surfaces 208. Each of the side wall portions 202 of the locking member 108 also preferably comprises an extension member opening 210 that extends through the side wall portion from the main outer surface 192 of the locking member and into the primary opening 194 of the locking member.

Each leg portion 204 is preferably attached to the upper portion 200 of the locking member 108 by a relatively thin bridge portion 212. Additionally, each leg portion 204 forms an actuation portion 214 as it extends downward. Beneath the actuation portions 214, each leg portion 204 extends radially outward from the main outer surface 192 of the locking member 108 in a manner forming a cam portion 116. The cam portion 116 of each leg portion 204 is preferably T-shaped, as viewed from above, in a manner such that the radially outer most part of the cam portion is wider than the spacing between the side wall portions 202 of the locking member 108 and in a manner forming a pair of bearing surfaces 218. The upper and radially outer most portion of each cam portion 216 has a rounded edge that forms a cam surface 220. Each cam surface 220 preferably increases in radius from its middle toward its opposite longitudinal ends. Finally, an arched recess 222 preferably extends radially outward from the inner most part of each of the cam portions 216 and upward from the bottom surface 196 of the locking member 108.

The various components of the scribing tool 100, formed as described above, are preferably assembled by first assembling the locking member 108 to the upper portion 144 of the tile engagement member 106. This is done by inserting the top portion 200 of the locking member 108 upward through the central opening 154 of the upper portion 144 of the tile engagement member 106 until the bearing surfaces 208 of the side wall portions 202 of the locking member engage the recessed cylindrical rim 158 of the top portion of the tile engagement member. During this procedure, the leg portions 204 of the locking member 108 are preferably deflected toward each other and are preferably maintained in such a position while the extension member 104 is then inserted through the extension member openings 210 that extend through the side wall portions 202 of the locking member. The extension member 104 is inserted through the extension member openings 210 of the side wall portions 202 by inserting either of the longitudinal ends 128 of the extension member therethrough.

With the extension member 104 inserted through the openings 210 of the side wall portions 202, the leg portions 204 of the locking member 108 are then released and the lower portion 146 of the tile engagement member 106 is preferably then assembled to the upper portion 144 of the tile engagement member. This is preferably done by aligning the locking tabs 152 of the upper portion 144 with the openings 174 of the lower portion 146, and thereafter pressing the upper and lower portions together. As this occurs, the cam surfaces 168 of the locking tabs 152 of the upper portion 144 engage the openings 174 of the lower portion 146, causing the locking tabs to resiliently deflect radially inward toward each other. Eventually, the bottom of the frustoconical wall portion 148 of the upper portion 144 engages the top surface 176 of the lower portion 146, at which point the locking surfaces 166 of the locking tabs 152 are positioned beneath the locking surfaces 190 of the lower portion. This allows the locking tabs 152 to at least partially return to their undeflected relative positions. As such, the locking surfaces 166 of the locking tabs 152 of the upper portion 144 and the locking surfaces 190 of the lower portion 146 then are positioned such that they cooperate to secure the upper and lower portions to each other.

The next step of assembling the scribing tool 100 preferably comprises attaching the scribe member 102 to the extension member 104. This is preferably done by simply inserting the nub 126 of the attachment portion 112 of the scribe member 102 upward through the opening 138 of the attachment portion 136 of the extension member 104 from beneath the partial frustoconical surface 140 of the extension member. The tapered nature of the partial frustoconical surface 140 of the opening 138 of the extension member 104 causes the nub 126 of the scribe member 102 to eventually engage against the partial frustoconical surface, which causes the opening to resiliently expand. The slot portion 142 of the opening 138 facilitates this by increasing the ability of the opening to resiliently expand. Eventually, the nub 126 of the scribe member 102 passes above the top 130 of the extension member 104, thereby allowing the opening 138 of the extension member to at least partially return to its undeflected configuration. However, the diameter of the column 124 of the attachment portion 112 of the scribe member 102 is preferably dimensioned to be slightly larger than the upper end of the partial frustoconical surface 140 of the extension member 104 such that the opening presses against the column and thereby creates friction. Nonetheless, with the nub 126 of the scribe member 102 positioned above the top 130 of the extension member 104 and the opening 138 of the extension member at least partially returned to its undeflected configuration, the nub then prevents the attachment portion 112 of the scribe member from moving downward relative to the extension member and thereby secures the scribe member to the extension member.

Having attached the various components of the scribing tool 100 to each other as recited above, the assembly of the scribing tool is then complete. As assembled, the scribe member 102 is pivotally connected to the extension member 104 about the center axis of the column 124 of the attachment portion 112 of the scribe member, but is otherwise rigidly connected thereto. However, pivotal movement of the scribe member 102 relative to the extension member 104 is frictionally inhibited by the friction between opening 138 of the extension member and the column 124 of the scribe member. As such, a torque in excess of a threshold amount is required therebetween to allow such pivotal movement. Thus, with an applied force, the scribe member 102 can be pivotally repositioned relative to the extension member 104, where it will remain unless intentionally repositioned.

The tile engagement member 106 of the scribing tool 100 is both pivotally and slideably connected to the extension member 104. However, the tile engagement member 106 is also frictionally lockable in position relative to the extension member 104 via the locking member 108. In particular, a force must be exerted on the locking member 108 to allow the tile engagement member 106 to pivotally and slideably move relative to the extension member 104. As shown in FIG. 23, absent an applied force, the locking member 108 preferably locks the extension member 104 relative to the tile engagement member 106 by forcing the extension member downward against the tile engagement member. In particular, the locking member 108 is preferably dimensioned such that the cam surfaces 220 of its leg portions 204 engage against the sloped cam surface 160 of the top wall portion 150 of the lower portion 144 of the tile engagement member 106 when not manually deflected. Thus, the biasing force that causes the leg portions 204 of the locking member 108 to resiliently deflect away from each other also forces the locking member downward relative to the tile engagement member 106. This movement causes the upper portion 200 of the locking member 108 to engage against the top 130 of the extension member 104 and thereby force the extension member downward until the bottom 132 of the extension member presses against the raised annular rim 156 of the upper portion 144 of the tile engagement member 106. As such, the extension member 104 becomes frictionally locked, both slideably and rotationally, to the tile engagement member 106.

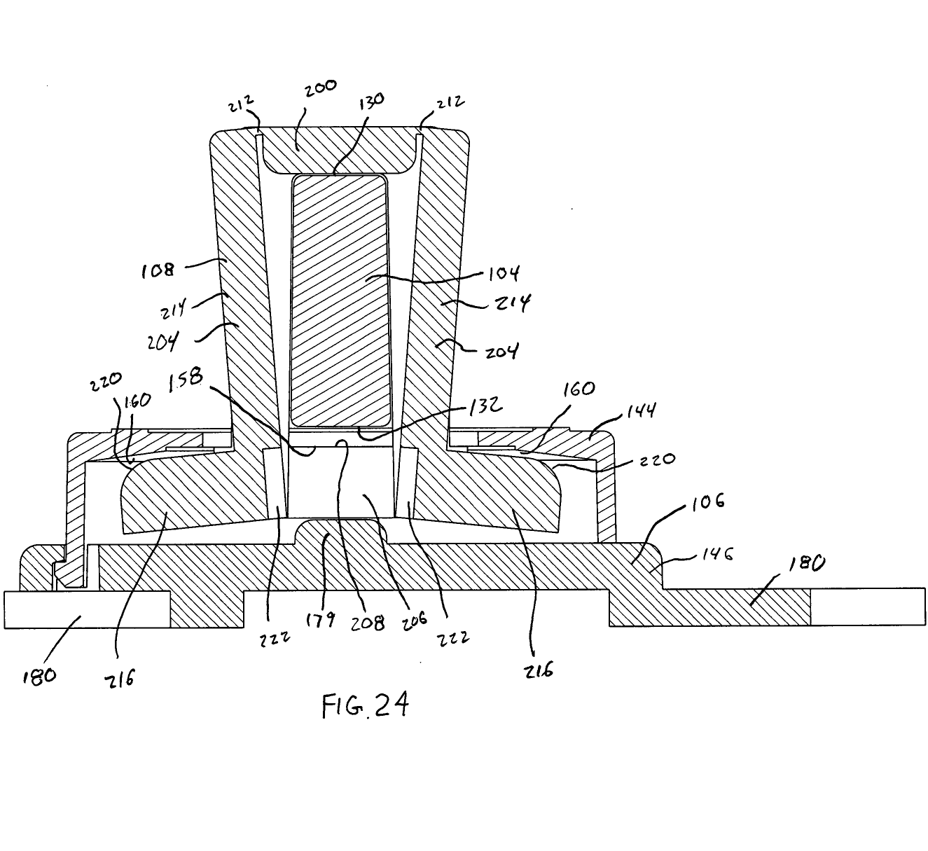

When desired, the extension member 104 can be moved, both slideably and rotationally, relative to the tile engagement member 106. This is done by simply manually exerting a squeezing force on the actuation portions 214 of the leg portions 204 of the locking member 108. This causes bending moments about the bridge portions 212 that connect the leg portions 204 to the upper portion 200 of the locking member 108, which then resiliently deflect and thereby allow the leg portions to pivot thereabout. When a sufficient force is applied, the leg portions 204 are deflected toward each other as shown in FIG. 24. Excessive deflection of the leg portions 204 toward each other is prevented by the bearing surfaces 218 on the cam portions 216 of the leg portions 204, which engage against the rim portions 206 of the side wall portions 202 of the locking member 108. This prevents the leg portions 204 from clamping the extension member 104 therebetween.

With the leg portions 204 of the locking member 108 deflected as shown in FIG. 24, the cam surfaces 220 of the locking member are disengaged with the sloped cam surface 160 of the upper portion 144 of the tile engagement member 106. This allows the locking member 108 to move upward relative to the tile engagement member 106, at least until the bearing surfaces 208 of the side wall portions 202 of the locking member engage against the recessed annular rim 158 of the upper portion 144 of the tile engagement member. By moving upward relative to the tile engagement member 106, the distance between the upper portion 200 of the locking member 108 and the raised annular rim 156 of the tile engagement member becomes slightly greater than the distance between the top 130 and bottom 132 of the extension member 104. As such, the extension member 104 is no longer clamped against the tile engagement member 106 by the locking member 108 and is therefore free to slideably move relative to both the tile engagement member and the locking member. Additionally, the extension member 104 and the locking member 108 are then allowed to pivot together relative to the tile engagement member 106. Thus, simply by squeezing the actuation portions 214 of the locking member 108 toward each other, the scribe member 102 of the scribing tool 100 can be moved toward or away from the tile engagement member 106 and can be simultaneously pivoted thereabout.

Upon releasing the locking member 108, the leg portions 204 resiliently deflect away from each other, causing the cam surfaces 220 of the locking member to once again engage the sloped cam surface 160 of the upper portion 144 of the tile engagement member 106. As a result of such engagement, the locking member 108 is forced downward relative to the tile engagement member 106, and thereby once again clamps the extension member 104 against the tile engagement member.

It should be appreciated that, over time, the resiliency of the locking member 108 may decrease. As such, the scribing tool 100 is configured such that a compression spring (not shown) can be added to the assembly to provide additional biasing force that further acts to move the leg portions 204 of the locking member 108 away from each other. In particular, the locking member 108 is configured such that a helical compression spring can easily be longitudinally positioned between the arched recesses 222 of the leg portions 204 in a semi-compressed state.

It should also be appreciated that the arched recesses 222 of the leg portions 204 will limit the horizontal and upward movement of such a spring and that the draft angles associated with the locking member 108 will tend to bow the spring downward. However, the nub portion 179 of the lower portion 146 of the tile engagement member 106 is configured to engage the spring so as to prevent it from being downwardly dislodged. Moreover, the nub portion 179 is configured to be relatively small in diameter such that it only minimally adds frictional resistance to the relative rotational movement between the tile engagement member 106 and the locking member 108 when the locking member is in its unlocked configuration.

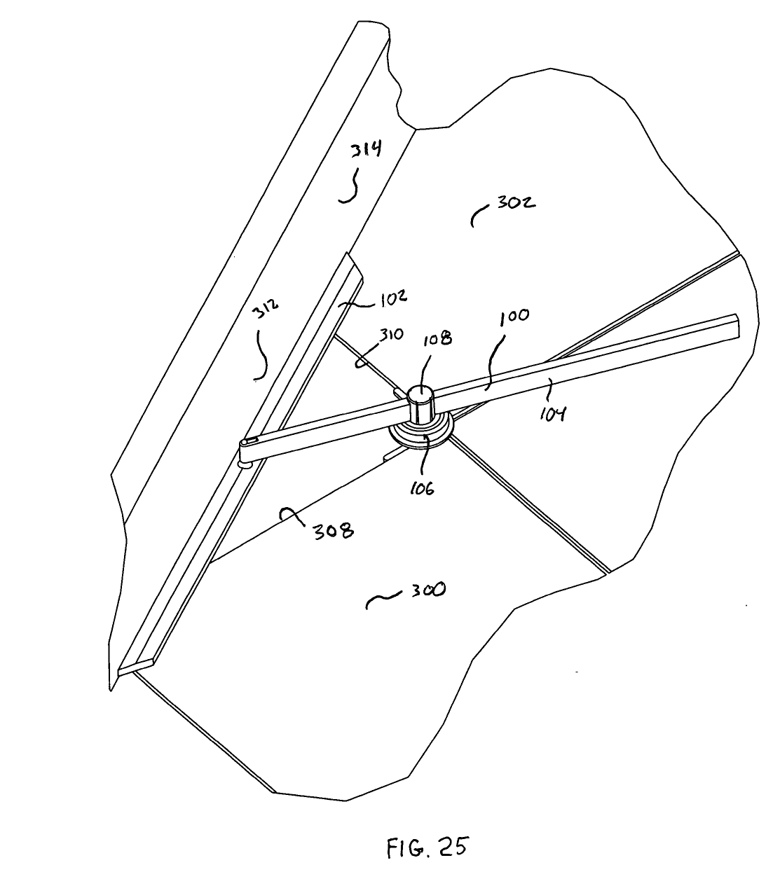

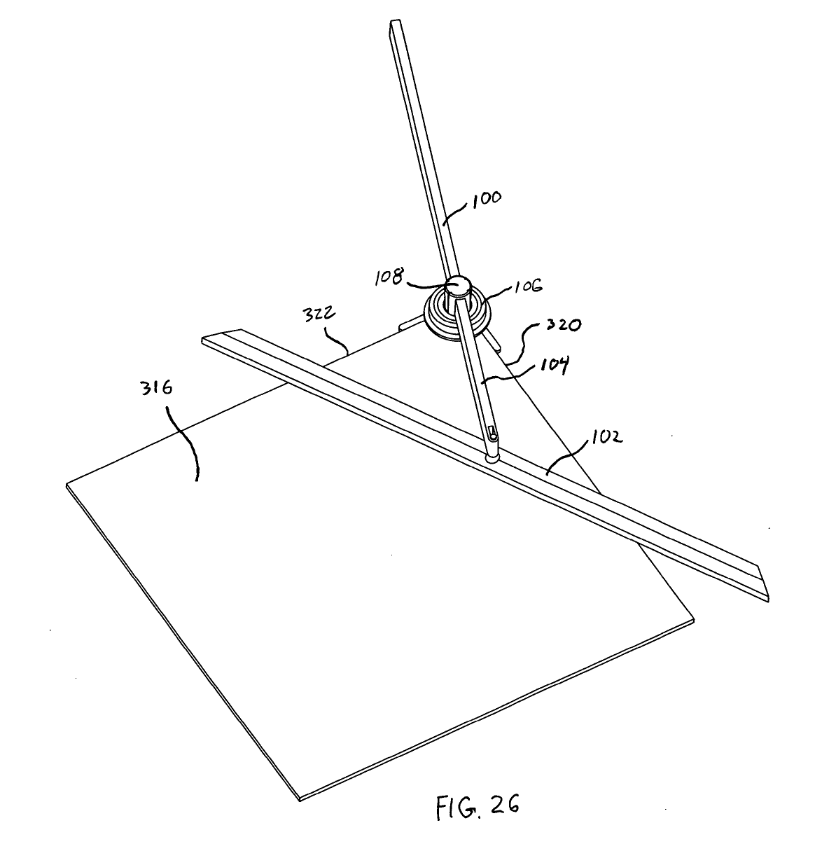

An example of the use of the scribing tool 100 is depicted in FIGS. 25 and 26. The exemplarily use of the scribing tool 100 shown in FIGS. 25 and 26 assumes that first 300 and second 302 tiles have been attached to a surface 304 where they define a space 306 therebetween on which a trimmed or cut tile is sought to be placed. The space 306 is partially bound by a straight edge 308 of the first tile 300, a straight edge 310 of the second tile 302, and a portion of a boundary perimeter 312. As shown, the portion of the boundary perimeter 312 is a portion of floorboard trim 314 that extends perpendicular to the surface 304 being tiled. However, it should be appreciated that the portion of the boundary perimeter 312 could be any desired boundary to which a tile placed in the space is desired to extend.

The scribing process preferably begins by aligning the straight edge 122 of the scribe member 102 of the scribing tool 100 with the boundary perimeter 312 that partially defines the space 306 onto which a tile is sought to be placed. Once aligned, the person using the scribe tool 100 holds the scribe member 102 in place with one hand, while using his or her other hand to squeeze the actuation portions 214 of the locking member 108 toward each other. With the actuation portions 214 squeezed and the scribe member 102 held in place as described, the tile engagement member 106 is then free to slide and pivot relative to the extension member 104. The person using the scribing tool 100 then preferably slides the locking member 108 and tile engagement member 106 toward the projected intersection of the straight edges 308, 310 of the first 300 and second tiles 302. As this occurs, it may be necessary to pivot the extension member 104 relative to the scribe member 102, which is achieved by merely exerting an uneven force sufficient to create a torque that overcomes the threshold moment required to pivot the scribe member relative to the extension member. Additionally, during this step, the first 182 and second 184 engagement portions of the lower portion 146 of the tile engagement member 106 engage against the straight edges 308, 310 of the first 300 and second 302 tiles, respectively. Because the tile engagement member 106 is free to pivot relative the extension member 104 when this occurs, the legs 180 of the lower portion 146 of the tile engagement member 106 automatically aligned themselves with the straight edges 308, 310 of the first 300 and second 302 tiles, as shown in FIG. 25, when they engage such edges. By configuring the tile engagement member 106 such that the legs 180 of the lower portion 146 of the tile engagement member 106 extend beyond the main body 170 of the lower portion, the proper alignment of the tile engagement member 106 with the edges 308, 310 of the first and second tiles can be visually verified.

With the above mentioned step complete, the person using the scribing tool 100 then preferably simply releases the scribe member 102 and the locking member 108, thereby locking the scribe member and the tile engagement member 106 in their relative position. Then, the person using the scribing tool 100 preferably positions the scribing tool above a yet to be placed or cut third tile 316, as shown in FIG. 26, while holding the extension member 104. During this step, the bottom 118 of the scribe member 102 and the bottom surface 178 of the lower portion 146 of the tile engagement member 106 are preferably engaged against the upper surface 318 of the third tile 316. Simultaneously, the person using the scribing tool 100 positions the scribing tool such that the third 186 and fourth 188 engagement portions of the legs 180 of the tile engagement member 106 engage and align with the first 320 and second 322 edges of the third tile 316, respectively. With the scribing tool 100 so placed, the person using the scribing tool then preferably firmly presses the scribe member 102 against the third tile 316 and cuts through or scribes a line on the third tile via a marking utensil or a cutting device, such as a blade. The scribing tool is then removed from the third tile 316 and the procedure may be repeated, such as when complex or multiple boundary perimeters 312 require multiple scribing. Finally, all unwanted portions of the third tile 316 are then cut away or otherwise removed from the third tile using conventional techniques.

Having completed the above-mentioned steps, the third tile 316 has the desired shape to be attached to the space 306 on the surface 304. Moreover, the spacing between the first 182 and third 186 engagement portions and between the second 184 and fourth 188 engagement portions of the tile engagement member 106 is preferably configured to be equal to the desired grout width between the laid tile. As such, when the third tile 316 is properly positioned against the portion of the boundary perimeter 312, it is also positioned the proper grout width from each of the first 300 and second 302 tiles.

In view of the foregoing, it should be appreciated that the scribing tool and its method of use allows people to rapidly scribe tile without measuring and without performing cumbersome other steps associated with previous scribing tools. Moreover, the scribing tool of the preferred embodiment automatically takes into account the grout width between the tile. To this end, it is preferable to sell the scribing tool as a kit with multiple lower portions of the tile engagement member that are each configured to accommodate specific standard grout widths. Yet further, it should be appreciated that the scribing tool of the preferred embodiment can be produced economically and, if desired, entirely out of plastic via two-part molds. Still further, the pivoting action between the extension member and both the tile engagement member and the scribe member makes the scribing tool extremely versatile. Thus, the scribing tool and method of the invention overcomes the disadvantages associated with previous methods and apparatus used to scribe tile and appreciably increases the efficiency of the vast majority of tiling projects.

While the present invention has been described in reference to a specific embodiment, in light of the foregoing, it should be understood that all matter contained in the above description or shown in the accompanying drawing figures is intended to be interpreted as illustrative and not in a limiting sense and that various modifications and variations of the invention may be constructed without departing from the scope of the invention defined by the following claims. Thus, it should be appreciated that the tile engagement portions of the locking member need not be portions of an L-Shaped protrusion, but instead could formed by multiple protrusions of practically any shape. For example, the third and fourth tile engagement portions could comprise protrusions that create two point-contacts for engaging against the first edge of the third tile and one point-contact for engaging against the second edge of the third tile. As such, basically any configuration that would allow the tile engagement member to be aligned with both the first and second edge of the third tile could suffice. Additionally, a non-frictionally based locking and release mechanism could be incorporated between the scribe member and the extension member to allow and prevent pivotal movement therebetween. Furthermore, such a locking and release mechanism could be biased to automatically prevent such pivotal movement when released. Moreover, the locking member need not be configured as described and could be configured to operate in an entirely different manner than described. Yet further, it should be appreciated that the scribe member could comprise multiple elements that are movable relative to each other or could even be flexibly adjustable, and that the scribe edge of the scribe member need not be a straight edge. Likewise, the locking member or the extension member could comprise multiple components. Thus, other possible variations and modifications of the claimed invention should be appreciated, but not limited.

Furthermore, it should be understood that when introducing elements of the present invention in the claims or in the above description of the preferred embodiment of the invention, the terms “comprising,” “including,” and “having” are intended to be open-ended and mean that there may be additional elements other than the listed elements. Similarly, the term “portion” should be construed as meaning some or all of the item or element that it qualifies.

1. An apparatus for scribing tile comprising:
a scribe member;
a tile engagement member;
an extension member, the extension member connecting the scribe member to the tile engagement member, the extension member being movably connected to the tile engagement member; and
a locking member, the locking member being movable between a locking position and an unlocking position, the locking member preventing movement of the tile engagement member relative to the extension member when the locking member is in the locking position and allowing movement of the tile engagement member relative to the extension member when the locking member is in the unlocking position, the locking member being biased from the unlocking position toward the locking position.

2. An apparatus in accordance with claim 1 wherein the extension member is both pivotally and slideably movable relative to the tile engagement member when the locking member is in the unlocking position.

3. An apparatus in accordance with claim 2 wherein the scribe member is pivotally connected to the extension member.

4. An apparatus in accordance with claim 3 wherein the scribe member is pivotally connected to the extension member by a friction connection in a manner such that there is a frictional force that prevents pivotal movement of the scribe member relative to the extension member unless at least a threshold moment between the scribe member and the extension member is applied.

5. An apparatus in accordance with claim 2 wherein the locking member comprises a cam surface and wherein the tile engagement member comprises a cam surface, the cam surface of the locking member engaging the cam surface of the tile engagement member when the locking member is in the locking position in a manner such that the extension member is in clamped engagement with the tile engagement member.

6. An apparatus in accordance with claim 2 wherein the locking member is pivotally movable with the extension member relative to the tile engagement member.

7. An apparatus in accordance with claim 2 wherein the extension member is pivotally movable relative to the tile engagement member about a pivot axis and wherein the locking member comprises an actuation portion, the actuation portion being movable toward the pivot axis in a manner to move the locking member from the locking position to the unlocking position and being movable away from the pivot axis in a manner to move the locking member from the unlocking position to the locking position.

8. An apparatus in accordance with claim 2 wherein the apparatus further comprises a resilient portion that allows the locking member to resiliently deflect between the locking position and the unlocking position.

9. An apparatus in accordance with claim 8 wherein the locking member is biased from the unlocking position toward the locking position via the resilient portion.

10. An apparatus in accordance with claim 1 wherein the scribe member is pivotally connected to the extension member.

11. An apparatus in accordance with claim 10 wherein the scribe member is pivotally connected to the extension member by a friction connection in a manner such that there is a frictional force that prevents pivotal movement of the scribe member relative to the extension member unless at least a threshold moment between the scribe member and the extension member is applied.

12. An apparatus in accordance with claim 1 wherein the apparatus further comprises a resilient portion that allows the locking member to resiliently deflect between the locking position and the unlocking position, the locking member being biased from the unlocking position toward the locking position via the resilient portion.

13. An apparatus in accordance with claim 1 wherein the apparatus further comprises first and second actuation portions, the first and second actuation portions each being movable relative to the tile engagement member, the first and second actuation portions also being movable toward each other in a manner to move the locking member from the locking position to the unlocking position and being movable away from each other in a manner to move the locking member from the unlocking position to the locking position.

14. An apparatus in accordance with claim 1 wherein the locking member comprises a cam surface and wherein the tile engagement member comprises a cam surface, the cam surface of the locking member engaging the cam surface of the tile engagement member when the locking member is in the locking position in a manner such that the extension member is in clamped engagement with the tile engagement member.

15. An apparatus in accordance with claim 1 wherein the scribe member consists of a single monolithic member having a straight scribe edge.

16. A method comprising:
providing a surface onto which it is desired to lay tile up to a boundary perimeter;
providing first, second, and third tiles, the first and second tiles each having a straight edge, the third tile having first and second straight edges;
securing the first and second tiles to the surface in a manner such that the edge of the first tile is oriented generally perpendicular to the edge of the second tile and in a manner defining a portion of the surface that is at least partially bound by the edge of the first tile, the edge of the second tile, and the boundary perimeter;
providing a scribing tool, the scribing tool comprising a scribe member, a tile engagement member, and an extension member, the extension member connecting the scribe member to the tile engagement member, the extension member being pivotally connected to the tile engagement member, the tile engagement member comprising first, second, third, and fourth engagement portions;
aligning the scribe member with a portion of the boundary perimeter;
engaging the tile engagement member with the first and second tiles by pivoting the tile engagement member relative to the extension member in a manner such that the first engagement portion of the tile engagement member engages the edge of the first tile and such that the second engagement portion of the tile engagement member engages the edge of the second tile while the scribe member is aligned with the portion of the boundary perimeter;
locking the tile engagement member relative to the extension member in a manner such that the scribe member is fixed in orientation relative to the tile engagement member with the tile engagement member engaged with the first and second tiles as recited and with the scribe member aligned with the portion of the boundary perimeter as recited;
engaging the tile engagement member with the third tile in a manner such that the third engagement portion of the tile engagement member engages the first edge of the third tile and such that the fourth engagement portion of the tile engagement member engages the second edge of the third tile while the tile engagement member is locked in the fixed orientation relative to the extension member, the first edge of the third tile being separated from the first engagement portion of the tile engagement member by a distance and the second edge of the third tile being separated from the second engagement portion of the tile engagement member by the distance when the tile engagement member is so engaged with the third tile; and
scribing the third tile via the scribe member when the tile engagement member is engaged with the third tile as recited.

17. A method in accordance with claim 16 wherein the step of providing the scribing tool occurs in a manner such that the scribing tool comprises a locking member, the locking member being movable between a locking position and an unlocking position, the locking member preventing movement of the tile engagement member relative to the extension member when the locking member is in the locking position and allowing movement of the tile engagement member relative to the extension member when the locking member is in the unlocking position, the locking member being biased from the unlocking position toward the locking position, the step of engaging the tile engagement member with the first and second tiles by pivoting the tile engagement member relative to the extension member occurring by exerting a force on the locking member so as to maintain the locking member in the unlocking position, the step of locking the tile engagement member relative to the extension member occurring by releasing the force on the locking member such that the locking member moves into the locking position as a result of the locking member being biased toward the locking position.

18. A method in accordance with claim 17 wherein the step of providing the scribing tool further occurs in a manner such that the extension member is slideably connected to the tile engagement member, and wherein the step of engaging the tile engagement member with the first and second tiles further occurs by sliding the tile engagement member relative to the extension member.

19. A method in accordance with claim 18 wherein the step of providing the scribing tool further occurs in a manner such that the scribe member is pivotally connected to the extension member, and wherein the step of engaging the tile engagement member with the first and second tiles further occurs by pivoting the scribe member relative to the extension member.

20. A method in accordance with claim 17 wherein the step of providing the scribing tool occurs in a manner such that the scribing tool comprises first and second actuation portions, the first and second actuation portions each being movable relative to the tile engagement member, the first and second actuation portions also being movable toward each other in a manner to move the locking member from the locking position to the unlocking position and being movable away from each other in a manner to move the locking member from the unlocking position to the locking position, the step of engaging the tile engagement member with the first and second tiles comprising exerting a force on the first and second actuation portions so as to cause the first and second actuation portions to move toward each other such that the locking member is in the unlocking position, the step of locking the tile engagement member relative to the extension member comprising releasing the force exerted on the first and second actuation portions so as to allow the first and second actuation portions to move away from each other such that the locking member moves into the locking position as a result of the locking member being biased toward the locking position.

21. A method in accordance with claim 16 wherein the step of providing the scribing tool further occurs in a manner such that the scribe member is pivotally connected to the extension member, and wherein the step of engaging the tile engagement member with the first and second tiles further occurs by pivoting the scribe member relative to the extension member.

22. A method in accordance with claim 21 wherein the step of providing the scribing tool occurs in a manner such that the scribing tool comprises a locking member, the locking member being movable between a locking position and an unlocking position, the locking member preventing movement of the tile engagement member relative to the extension member when the locking member is in the locking position and allowing movement of the tile engagement member relative to the extension member when the locking member is in the unlocking position, the locking member being biased from the unlocking position toward the locking position, the step of engaging the tile engagement member with the first and second tiles by pivoting the tile engagement member relative to the extension member occurring by maintaining a force on the locking member so as to maintain the locking member in the unlocking position, the step of locking the tile engagement member relative to the extension member occurring by releasing the force on the locking member such that the locking member moves into the locking position as a result of the locking member being biased toward the locking position.

23. A method in accordance with claim 22 wherein the step of providing the scribing tool occurs in a manner such that the scribing tool comprises first and second actuation portions, the first and second actuation portions each being movable relative to the tile engagement member, the first and second actuation portions also being movable toward each other in a manner to move the locking member from the locking position to the unlocking position and being movable away from each other in a manner to move the locking member from the unlocking position to the locking position, the step of engaging the tile engagement member with the first and second tiles comprising exerting a force on the first and second actuation portions so as to move the first and second actuation portion toward each other such that the locking member is in the unlocking position, the step of locking the tile engagement member relative to the extension member comprising releasing the force exerted on the first and second actuation portions so as to allow the first and second actuation portions to move away from each other such that the locking member moves into the locking position as a result of the locking member being biased toward the locking position.

24. A method in accordance with claim 21 wherein the step of providing the scribing tool further occurs in a manner such that the extension member is slideably connected to the tile engagement member, and wherein the step of engaging the tile engagement member with the first and second tiles further occurs by sliding the tile engagement member relative to the extension member.

25. A method comprising:
providing a scribing tool, the scribing tool comprising a scribe member, a tile engagement member, an extension member, and a locking member, the extension member connecting the scribe member to the tile engagement member and being movably connected to the tile engagement member, the locking member being movable between a locking position and an unlocking position, the locking member preventing movement of the tile engagement member relative to the extension member when the locking member is in the locking position and allowing movement of the tile engagement member relative to the extension member when the locking member is in the unlocking position, the locking member being biased from the unlocking position toward the locking position;
moving the extension member relative to the tile engagement member by applying a force causing the locking member to move out of the locking position and into the unlocking position; and
releasing the applied force on the locking member in a manner such that the locking member moves out of the unlocking position and into the locking position as a result of the locking member being biased from the unlocking position toward the locking position.

26. A method in accordance with claim 25 wherein the step of moving the extension member relative to the tile engagement member occurs in a manner such that the extension member pivots and slides relative to the tile engagement member.

27. A method in accordance with claim 26 wherein the method further comprises a step of pivoting the scribe member relative to the extension member.

28. A method in accordance with claim 25 wherein the method further comprises a step of pivoting the scribe member relative to the extension member.

29. A method in accordance with claim 28 wherein the step of pivoting the scribe member relative to the extension member comprises applying a moment between the extension member and the scribe member that is sufficient to overcome a threshold moment caused by friction that otherwise prevents pivotal movement between the extension member and the scribe member.

30. A method in accordance with claim 25 wherein the step of moving the extension member relative to the tile engagement member occurs in a manner such that the extension member pivots relative to the tile engagement member, and wherein the step of moving the extension member relative to the tile engagement member occurs in a manner such that the locking member pivots with the extension member relative to the tile engagement member.

31. A method in accordance with claim 25 wherein the step of providing the scribing tool occurs in a manner such that the extension member is pivotally connected to the tile engagement member and such that the tile engagement member comprises first, second, third, and fourth engagement portions, the method further comprising the steps of:
providing a surface onto which it is desired to lay tile thereonto up to a boundary perimeter;
providing first, second, and third tiles, the first and second tiles each having a straight edge, the third tile having first and second straight edges;
securing the first and second tiles to the surface in a manner such that the edge of the first tile is oriented generally perpendicular to the edge of the second tile and in a manner defining a portion of the surface that is at least partially bound by the edge of the first tile, the edge of the second tile, and the boundary perimeter;
aligning the scribe member with a portion of the boundary perimeter and with the first and second tiles secured to the surface as recited;
engaging the tile engagement member with the first and second tiles by pivoting the tile engagement member relative to the extension member in a manner such that the first engagement portion of the tile engagement member engages the edge of the first tile and such that the second engagement portion of the tile engagement member engages the edge of the second tile while the scribe member is aligned with the portion of the boundary perimeter;
locking the tile engagement member relative to the extension member in a manner such that the scribe member is fixed in orientation relative to the tile engagement member with the tile engagement member engaged with the first and second tiles as recited and with the scribe member aligned with the portion of the boundary perimeter as recited;
engaging the tile engagement member with the third tile in a manner such that the third engagement portion of the tile engagement member engages the first edge of the third tile and such that the fourth engagement portion of the tile engagement member engages the second edge of the third tile while the tile engagement member is locked in the fixed orientation relative to the extension member, the first edge of the third tile being separated from the first engagement portion of the tile engagement member by a distance and the second edge of the third tile being separated from the second engagement portion of the tile engagement member by the distance when the tile engagement member is so engaged with the third tile; and
scribing the third tile via the scribe member when the tile engagement member is engaged with the third tile as recited.

32. A method in accordance with claim 31 wherein the step of providing the scribing tool occurs in a manner such that the tile engagement member comprises an L-shaped protrusion that forms the first, second, third, and fourth engagement portions.

33. A method in accordance with claim 25 wherein the step of moving the extension member relative to the tile engagement member occurs in a manner such that the locking member resiliently deflects.

34. A method in accordance with claim 33 wherein the step of providing the scribing tool occurs in a manner such that the locking member is biased from the unlocking position toward the locking position solely by the resilient deflection of the locking member.
